(19) United States
(12) Patent Application Publication
(10) Pub. No.: US 2026/0097415 A1
(43) Pub. Date: Apr. 9, 2026

(54) ADVANCED DIP-COATING EQUIPMENT AND DIP-COATING METHOD USING THE SAME

(71) Applicant: Korea Institute of Energy Technology, Naju-si (KR)

(72) Inventors: Hyo Won KIM, Gwangmyeong-si (KR); Nam Gyu LIM, Naju-si (KR)

(21) Appl. No.: 19/348,952

(22) Filed: Oct. 3, 2025

(30) Foreign Application Priority Data
Oct. 8, 2024 (KR) 10-2024-0136161
Aug. 21, 2025 (KR) 10-2025-0116534

(51) Int. Cl. B05C 11/06; B05C 3/09; B05C 11/10; B05C 13/02

(52) U.S. Cl. CPC B05C 11/06; B05C 3/09; B05C 11/1007; B05C 13/025

(57) ABSTRACT

The present disclosure relates to an advanced dip-coating apparatus and a dip-coating method using the same. More specifically, the present disclosure relates to an advanced dip-coating technology that prevents meniscus formation, inhibits infiltration into pores inside of a support, forms a thin film having a uniform thickness and provides a defect-free dense thin film coating layer by controlling the three parameters of coating solution viscosity, substrate withdrawing rate and air spinning flow rate.

### CROSS-REFERENCE TO RELATED APPLICATION

This application claims priority to Korean Patent Application Nos. 10-2024-0136161 and 10-2025-0116534, filed on Oct. 8, 2024 and Aug. 21, 2025, respectively, and all the benefits accruing therefrom under 35 U.S.C. § 119, the contents of which in its entirety are herein incorporated by reference.

### BACKGROUND

### 1. Field

The present disclosure relates to an advanced dip-coating apparatus and a dip-coating method using the same. More specifically, the present disclosure relates to an advanced dip-coating apparatus and dip-coating method that form a uniform and defect-free thin film by controlling the three parameters of coating solution viscosity, substrate withdrawing rate and air spinning flow rate.

### 2. Description of the Related Art

Recently, technologies of forming a uniform thin film have been increasingly in demand in various fields, such as electronic devices, energy conversion systems, separators and optical devices. Particularly, polymer thin films have been used widely in sensors, membranes, coating materials, electrochemical devices, etc., by virtue of their advantages, such as light weight, flexibility and chemical stability. To obtain such polymer thin films, a solution-based low-cost large-area process is required, and one of the typical methods is a dip-coating process.

The dip-coating process is a technology of forming a solid film by dipping a substrate in a polymer solution, withdrawing the substrate at a constant rate to form a solution film on the surface thereof, and carrying out solvent evaporation or heat treatment. During the process, the thickness of a film is determined by solution viscosity, surface tension, density, withdrawing rate and drying conditions, and can be estimated based on the Landau-Levich-Derjaguin theory. The process is advantageous in that it uses an equipment having a simple constitution and can be applied to various shapes, such as a sheet-like, cylindrical and hollow fiber membrane shapes.

Particularly, the dip-coating technology for forming polymer films is widely used for gas separation membranes, ion exchange membranes, electrolyte membranes, bio-sensor protective layers, or the like. For example, when a selective layer is formed on the surface of a porous ceramic support or hollow fiber membrane by using a solution, including a polymer, such as polyimide (PI), polyether sulfone (PES), polymethyl methacrylate (PMMA), etc., dissolved in a solvent (dimethyl formamide (DMF), N-methyl-2-pyrrolidone (NMP), etc.), it is possible to ensure high selectivity and mechanical stability at the same time.

In addition, manufacture of a polymer thin film using dip-coating allows large-area coating, low-cost mass production and multilayer coating, and thus its application has been expanded in various industrial fields, including semiconductor fabrication, optical coating, manufacture of electrodes for batteries and fuel cells, or the like.

However, such a dip-coating process has limitations, including meniscus line defects, thickness non-uniformity and difficulty in controlling solution evaporation rate, and thus there is a need for developing a novel technology capable of solving this.

### REFERENCES

### Patent Documents

(Patent Document 1) Japanese Patent Publication No. 2629417 B2
(Patent Document 2) Japanese Patent Laid-Open No. 1995-241509 A

### Non-Patent Documents

(Non-Patent Document 1) Zhang, Zhao, Fei Peng, and Konstantin G. Kornev. “The thickness and structure of dip-coated polymer films in the liquid and solid states.” Micromachines 13.7 (2022): 982

### SUMMARY

The present disclosure is directed to providing a novel dip-coating technology which solves the problem of formation of a thin film having a difference in thickness between the upper part and the lower part, occurring in the related art, and forms a uniform-thin film coating layer.

In one aspect, there is provided a dip-coating apparatus including: a solution tank in which a coating solution is stored; a substrate-providing unit configured to dip a substrate in the coating solution and to withdraw the substrate out of the coating solution; an air-discharging unit configured to supply air to the substrate at a constant flow rate when the dipped substrate is lifted up; and a rate-controlling unit configured to control the substrate dipping rate and withdrawing rate, wherein the substrate-providing unit includes a tubular body configured to fix the substrate and to locate the substrate in the solution tank, the air-discharging unit includes a discharging tube through which air is discharged to the outside, the discharging tube is linked with an air compressor through a tube, and the rate-controlling unit is installed to be linked with the substrate-providing unit and is an automated device configured to insert the substrate to the solution tank at a constant rate, to allow the substrate to be dipped in the coating solution for a predetermined time and to withdraw the substrate out of the solution tank at a constant rate to be located at its original position.

In another aspect, there is provided an advanced dip-coating method using the dip-coating apparatus, including the steps of: (A) dipping a substrate in a coating solution for a predetermined time; (B) withdrawing the dipped substrate out of the coating solution; (C) supplying air to the substrate as soon as the substrate is started to be withdrawn out.

The advanced dip-coating apparatus according to the present disclosure can provide effects of preventing meniscus formation of a thin film and forming a thin film coating layer having a uniform thickness and free from defects.

In addition, the advanced dip-coating apparatus according to the present disclosure can provide an effect of forming a polymer thin film having a uniform and constant thickness on the surface of a porous ceramic support.

### BRIEF DESCRIPTION OF THE DRAWINGS

FIG. 1 is a schematic view illustrating a conventional dip-coating process.

FIG. 2 is a schematic view illustrating a dip-coating process according to the present disclosure in comparison with a dip-coating process according to the related art.

FIG. 3 is a schematic view illustrating an advanced dip-coating apparatus according to the present disclosure.

FIGS. 4A and 4B are graphs illustrating viscosity and surface tension of a coating solution measured depending on concentration thereof.

FIG. 5 is a graph illustrating a change in thickness of a thin film measured depending on substrate withdrawing rate.

FIG. 6 is a graph illustrating oxygen/nitrogen selectivity depending on air spinning flow rate and whether air spinning is used or not.

FIG. 7 is a scanning electron microscopic (SEM) image of a hollow fiber thin film composite membrane depending on whether air spinning is used or not.

FIG. 8 is an image illustrating the cross-section of a hollow fiber thin film composite membrane depending on air spinning flow rate and whether air spinning is used or not, as analyzed by scanning electron microscopy/energy dispersive X-ray spectroscopy (SEM/EDS).

FIG. 9 is a graph illustrating a depth profile of a hollow fiber thin film composite membrane determined by X-ray photoelectron spectroscopy (XPS), depending on air spinning flow rate and whether air spinning is used or not.

FIG. 10 is a graph illustrating gas permeability and selectivity depending on air spinning flow rate and whether air spinning is used or not.

FIG. 11 is a graph illustrating gas permeability and selectivity of a heat-converted thin film composite membrane depending on air spinning flow rate and whether air spinning is used or not.

### DETAILED DESCRIPTION

Hereinafter, the present disclosure will be explained in more detail with reference to the accompanying drawings.

The present disclosure relates to an advanced dip-coating system. More specifically, the present disclosure can provide a novel dip-coating system that forms a uniform thin film by controlling coating solution viscosity, substrate withdrawing rate and air spinning flow rate in order to substitute for a conventional dip-coating process.

An exemplary embodiment of the present disclosure relates to a dip-coating apparatus configured to carry out an advanced dip-coating process.

A dip-coating process is a process including dipping a substrate vertically in a coating solution containing a diluted solution of a material from which a thin film is to be formed for approximately 1 minute and then withdrawing the substrate therefrom, followed by drying.

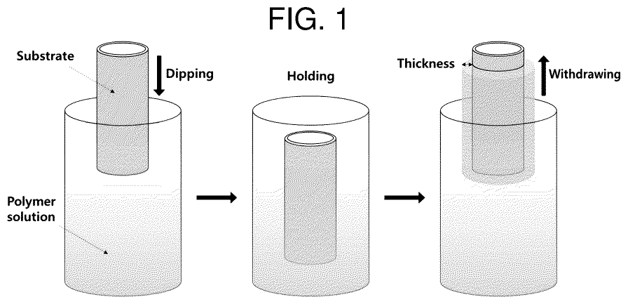

FIG. 1 is a schematic view illustrating such a conventional dip-coating process simply.

The dip-coating process is advantageous in that it allows easy operation, causes little waste of coating solution and enables coating of the surface of a whole product having a complicated shape or three-dimensional design. However, there are limitations in that a film formed through a dip-coating process shows a difference in thickness between the upper part and the lower part, or a non-uniform coating layer may be formed due to blocking of pores caused by dipping of the substrate.

To solve the above-mentioned problems, the present disclosure provides a dip coating apparatus including: a solution tank in which a coating solution is stored; a substrate-providing unit configured to dip a substrate in the coating solution and to withdraw the substrate out of the coating solution; an air-discharging unit configured to supply air to the substrate at a constant flow rate when the dipped substrate is lifted up; and a rate-controlling unit configured to control the substrate dipping rate and withdrawing rate.

Herein, the substrate-providing unit includes a tubular body configured to fix the substrate and to locate the substrate in the solution tank, the air-discharging unit includes a discharging tube through which air is discharged to the outside, the discharging tube is linked with an air compressor through a tube, the rate-controlling unit is installed to be linked with the substrate-providing unit and is an automated device configured to insert the substrate to the solution tank at a constant rate, to allow the substrate to be dipped in the coating solution for a predetermined time and to withdraw the substrate out of the solution tank at a constant rate to be located at its original position.

The dip-coating apparatus according to the present disclosure can control a rate of withdrawing a substrate out of a coating solution and air spinning flow rate together with a conventional process of controlling coating solution viscosity, when forming a thin film through a dip-coating process, in order to prevent meniscus formation having the highest effect upon the thickness of the thin film and formation of a uniform coating layer.

The thin film formed by using the dip-coating apparatus according to the present disclosure not only has a uniform thickness but also minimizes infiltration into the pores of a support, thereby forming a dense and uniform thin film coating layer.

In the dip-coating apparatus according to the present disclosure, the substrate-providing unit can dip the substrate vertically in the coating solution, the air-discharging unit can supply air toward the substrate as soon as the substrate is started to be lift up.

In addition, the substrate-providing unit and the air-discharging unit are disposed above the solution tank, and the discharging tube of the air-discharging unit is installed downward. In this manner, air can be supplied to the substrate while it is discharged and drop vertically.

Since the coating layer on the substrate still exists in a liquid state right after the substrate is withdrawn out of the coating solution, air spinning may be carried out to perform rapid thin filming of the coating solution applied to the substrate. In addition, air spinning allows thickness uniformity and prevention of defects, and thus it may function as an important parameter in a dip-coating process.

Particularly, when air spinning is started toward the substrate at a constant flow rate as soon as the substrate is started to be withdrawn out of the coating solution, it is possible to realize the unique effect of the present disclosure in that the polymer thin film formed on the porous ceramic support cannot infiltrate into the pores of the support, and a defect-free dense thin film is formed only on the surface of the support to a constant and uniform thickness.

Further, according to the present disclosure, air spinning may cause generation of air flow from conventionally used air or inert gas with no particular limitation.

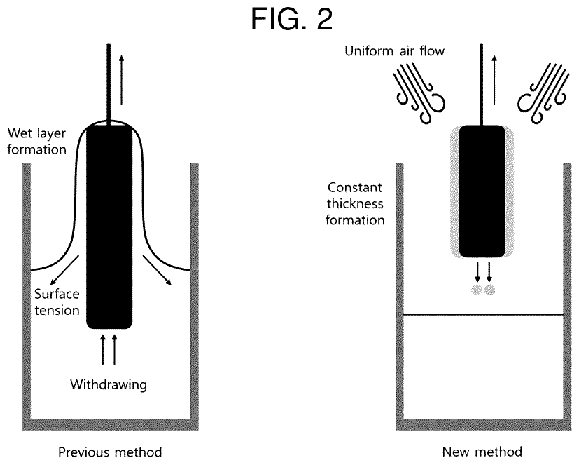

Referring to FIG. 2, it can be seen that a thin film is formed while the dip-coating apparatus according to the present disclosure inhibits infiltration of the coating solution into the pores.

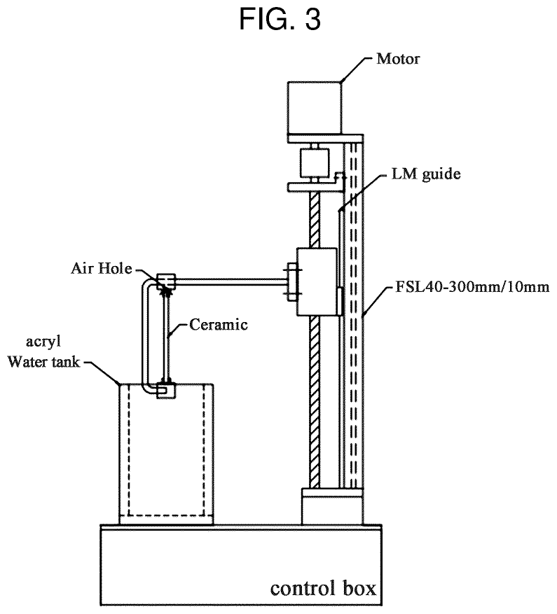

FIG. 3 is a schematic view illustrating a dip-coating apparatus and dip-coating system according to an embodiment of the present disclosure.

According to the present disclosure, the solution tank may further include: a level-detecting means configured to detect the level of the coating solution; and a level-maintaining means configured to maintain the level of the coating solution constantly.

It is preferred that the solution tank further comprises the level-detecting means and the level-maintaining means, since they can automatically control the level of coating solution in the solution tank and can fill the solution tank with the coating solution as necessary, which is advantageous to automation of the process and mass production.

In the present disclosure, the air-discharging unit may further include a flow meter configured to supply air at a constant flow rate; and a feed valve.

More specifically, the air-discharging unit can supply air to the substrate at a constant flow rate of 1 to 50 L/min, more preferably 15 to 25 L/min, and most preferably 20 to 25 L/min, by the flow meter and feed valve.

When the air flow rate is less than 1 L/min, defects may be generated upon the formation of a thin film. When the air flow rate is larger than 50 L/min, the thin film layer may have an excessively large thickness, or the coating material may be scattered dispersedly by strong air flow, which is not preferred.

In the present disclosure, the rate-controlling unit may be an automated device configured to insert the substrate to the solution tank at a rate of 0.1 to 50 mm/s, to allow the substrate to be dipped in the coating solution for 10 to 300 seconds and to withdraw the substrate out of the solution tank at the same rate to be located at its original position.

The substrate may be inserted into the solution tank at a rate more preferably of 0.5 to 10 mm/s, most preferably of 1 to 3 mm/s and then withdrawn out. When the rate is less than 0.1 mm/s, the thin film may have an excessively small thickness or cannot be formed undesirably. When the rate is larger than 50 mm/s, the thin film may have an excessively large thickness and may not be formed with a uniform thickness, which is not preferred.

In addition, the substrate may be dipped in the coating solution more preferably for 30 to 100 seconds, most preferably for 60 to 80 seconds. When the dipping time is less than 10 seconds, thin film formation may not be accomplished properly or defects may be generated. When the dipping time is larger than 300 seconds, the thin film may have an excessively large thickness, which is not preferred.

In the present disclosure, the coating solution may be a solution containing a polymer material and having a viscosity of 5 to 30 cP. The coating solution may have a viscosity more preferably of 10 to 25 cP, most preferably of 15 to 20 cP. When the coating solution has a viscosity of less than 5 cP or larger than 30 cP, defects may be generated upon the formation of a thin film, and the thin film shows a difference in thickness between the upper part and the lower part, which is not preferred.

In addition, the dip-coating apparatus according to the present disclosure may be an apparatus for manufacturing a composite membrane having a polymer selective layer formed on a porous ceramic support.

The porous ceramic support shows excellent mechanical strength, heat resistance and chemical resistance but has no selectivity, and thus a composite membrane for gas or water treatment may be obtained by forming a polymer selective layer responsible for substantial separation on the surface of the porous ceramic support.

According to an exemplary embodiment, a polyimide (PI) selective layer may be formed on the surface of an alumina (Al₂O₃) support to obtain a CO₂/CH₄ or O₂/N₂ gas separation membrane.

Further, according to the present disclosure, the substrate may be any one selected from a silicon substrate, a plastic substrate, a glass substrate, a metal substrate, a quartz, a metal oxide substrate and a metal nitride substrate, besides a ceramic support, but is not limited thereto.

Another exemplary embodiment of the present disclosure relates to an advanced dip-coating method using the dip-coating apparatus according to the present disclosure.

Specifically, the dip-coating method may include the steps of: (A) dipping a substrate in a coating solution for a predetermined time; (B) withdrawing the dipped substrate out of the coating solution; (C) supplying air to the substrate as soon as the substrate is started to be withdrawn out.

Herein, the substrate may be fixed at the substrate-providing unit of the dip-coating apparatus, dipped into the coating solution at a constant rate and then withdrawn out at a constant rate.

Hereinafter, the advanced dip-coating process according to the present disclosure will be explained in detail.

According to the present disclosure, step (A) is a step of dipping a substrate in a coating solution containing a polymer material for coating, wherein the substrate may be dipped at a constant rate for a predetermined time by the rate-controlling unit of the substrate-providing unit.

In step (A) according to the present disclosure, the substrate may be dipped into the coating solution at a rate of 0.1 to 10 mm/s, and the dipped substrate may be retained in a dipped state for 10 to 300 seconds.

The substrate may be inserted to the solution tank more preferably at a rate of 0.5 to 5 mm/s, most preferably 1 to 3 mm/s, and dipped in the coating solution more preferably for 30 to 100 seconds, most preferably 60 to 80 seconds. When the rate and time are less than 0.1 mm/s and 10 seconds, respectively, the thin film may have an excessively small thickness or cannot be formed undesirably. When the rate and time are larger than 10 mm/s and 100 seconds, respectively, the thin film may have an excessively large thickness and may not be formed with a uniform thickness, which is not preferred.

According to the present disclosure, step (B) is a step of withdrawing the dipped substrate out of the coating solution and carrying out drying, wherein the substrate may be withdrawn out at a constant rate by the rate-controlling unit of the substrate-providing unit.

In step (B) according to the present disclosure, the substrate may be withdrawn out of the coating solution at a rate of 0.1 to 10 mm/s.

The substrate may be withdrawn out more preferably at a rate of 0.5 to 5 mm/s, most preferably of 1 to 3 mm/s. When the rate is less than 0.1 mm/s, the thin film may have an excessively small thickness or cannot be formed undesirably. When the rate is larger than 10 mm/s, the thin film may have an excessively large thickness and may not be formed with a uniform thickness, which is not preferred.

According to the present disclosure, step (C) is a step of carrying out air spinning to form a dense thin film having a uniform thickness, wherein air spinning is started as soon as the substrate is withdrawn out of the coating solution so that a uniform coating layer may be formed.

In step (C) according to the present disclosure, air may be supplied to the substrate from the air-discharging unit of the dip-coating apparatus at a flow rate of 1 to 50 L/min.

Herein, air may be supplied more preferably at a flow rate of 15 to 25 L/min, most preferably 15 to 20 L/min. When the air flow rate is less than 1 L/min, defects may be generated upon the formation of a thin film. When the air flow rate is larger than 25 L/min, the thin film layer may have an excessively large thickness, or the coating material may be scattered dispersedly by strong air flow, which is not preferred.

Particularly, since the air spinning flow rate in step (C) is a parameter that plays an important role in the effects unique to the present disclosure of allowing the polymer thin film to be formed as a defect-free dense thin film only on the surface of the porous ceramic support to a uniform thickness with no infiltration into the pores of the support, it is preferred that the above-defined range is satisfied.

In addition, in steps (A) to (C) according to the present disclosure, the coating solution may have a viscosity of 5 to 30 cP.

More specifically, according to an exemplary embodiment of the present disclosure in which a composite membrane having a polymer selective layer formed on a porous ceramic support, the coating solution may be a solution containing a polymer at 10 to 30 wt %.

In addition, the coating solution may have a viscosity more preferably of 10 to 25 cP, most preferably of 15 to 20 cP. When the coating solution has a viscosity of less than 5 cP or larger than 30 cP, defects may be generated upon the formation of a thin film and the thin film shows a difference in thickness between the upper part and the lower part, which is not preferred.

According to a preferred exemplary embodiment of the present disclosure, the polymer contained in the coating solution may be at least one selected from the group consisting of polyvinyl alcohol (PVA), polyvinyl pyrrolidone (PVP), polymethyl methacrylate (PMMA), polystyrene (PS), polyimide (PI), polydimethyl siloxane (PDMS), polyvinylidene fluoride (PVDF), polyether sulfone (PES), polyetherimide (PEI), poly(3-hexylthiophene) (P3HT) and poly(3,4-ethylenedioxythiophene):polystyrene polysulfonate (PEDOT:PSS). However, there is no particular limitation in the polymer as long as it is a polymer used currently in the art.

In addition, according to an exemplary embodiment, the coating solution may include at least one solvent selected from the group consisting of dimethylfomamide (DMF), N-methyl-2-pyrrolidoen (NMP), dimethyl sulfioxide (DMSO), dimethylacetamide (DMAc), toluene and chlorobenzene. However, there is no particular limitation in the polymer as long as it is a solvent used currently in the art.

Hereinafter, preferred examples of the present disclosure will be described so that the present disclosure may be understood with ease. However, it should be understood that such preferred examples are given by way of illustration only, and the scope of the present disclosure is not limited thereto. It is apparent to those skilled in the art that various changes and modifications may be made within the scope of the present disclosure.

### EXAMPLES

### Example 1: Advanced Dip-Coating Process

A porous ceramic hollow fiber membrane made of Al₂O₃ was washed through ultrasonication in ethanol for 30 minutes and dried in a vacuum oven at 120° C. To form a 6FDA-ODA polyamic acid selective layer on the surface of the porous ceramic hollow fiber membrane, 6FDA-ODA polyamic acid was dissolved in DMF solvent, thereby preparing a 20 wt % polymer solution. Then, the solution tank of a dip-coating apparatus was filled with the polymer solution.

The dried hollow fiber membrane was fixed at the substrate-providing unit of the dip-coating apparatus and allowed to drop to the solution tank. After dipping the hollow fiber membrane for 1 minute, the hollow fiber membrane was withdrawn out at a rate of 1 mm/s. As soon as the hollow fiber membrane is started to be withdrawn out, air spinning was also carried out at a flow rate of 25 L/min to form a 6FDA-ODA polyamic acid thin film on the porous ceramic hollow fiber membrane.

### Example 2. Dip-Coating Process 1 Using Different Substrate Withdrawing Rate

A polymer thin film was formed by carrying out dip-coating in the same manner as Example 1, except that the hollow fiber membrane was withdrawn out at a rate of 2 mm/s instead of 1 mm/s.

### Example 3. Dip-Coating Process 2 Using Different Substrate Withdrawing Rate

A polymer thin film was formed by carrying out dip-coating in the same manner as Example 1, except that the hollow fiber membrane was withdrawn out at a rate of 3 mm/s instead of 1 mm/s.

### Example 4. Dip-Coating Process 1 Using Different Air Spinning Flow Rate

A polymer thin film was formed by carrying out dip-coating in the same manner as Example 1, except that the air spinning was carried out at a rate of 15 L/min instead of 25 L/min.

### Example 5. Dip-Coating Process 2 Using Different Air Spinning Flow Rate

A polymer thin film was formed by carrying out dip-coating in the same manner as Example 1, except that the air spinning was carried out at a rate of 20 L/min instead of 25 L/min.

### Comparative Example 1. Dip-Coating Process Using No Air Spinning

A polymer thin film was formed by carrying out dip-coating in the same manner as Example 1, except that the hollow fiber membrane was withdrawn out at a rate of 1 mm/s, and air spinning was not carried out.

### Test Examples

### Test Example 1. Determination of Viscosity and Surface Tension Depending on Coating Solution Concentration

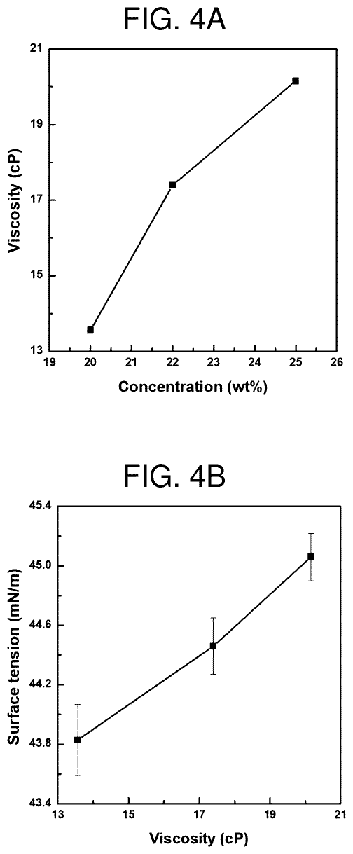

The viscosity and surface tension of a coating solution used in the dip-coating process according to the present disclosure were determined depending on the coating solution concentration. The results are shown in FIGS. 4A and 4B.

FIG. 4A is a graph illustrating the viscosity (cP) of a polymer solution depending on the polymer solution concentration (wt %), and FIG. 4B is a graph illustrating the surface tension (mN/m) depending on the viscosity (cP).

The viscosity was determined by preparing a polymer solution having a concentration of 20 to 25 wt % according to the method of ASTM D2196. In addition, DV2T available from Brookfield was used as a device for determining viscosity, 0.5 mL of the polymer solution was loaded at 25° C. in Con Plate Mode, and the device was set at a torque of 50%.

Referring to FIG. 4A, the viscosity increases as the concentration of the polymer solution increases. Specifically, it can be seen that a viscosity of about 13 cP appears at 20 wt %, about 17 cP appears at 22 wt %, and about 20 cP appears at 25 wt %.

The surface tension was determined by preparing the polymer solution in FIG. 4A at the same concentration according to the method of ISO 304. In addition, Tension Meter K9 available from KRUSS was used as a device for determining surface tension, 20 g of the polymer solution was applied to the O-ring and surface tension (Ae) was determined in the Max measurement mode.

Referring to FIG. 4B, it can be seen that the surface tension increases as the viscosity of the polymer solution increases.

Therefore, with reference to the coating solution concentration as the first parameter of a dip-coating process, it can be seen from Test Example 1 that the viscosity and surface tension of a coating solution increase as the concentration of the coating solution increases.

### Test Example 2. Determination of Thin Film Thickness Depending on Substrate Withdrawing Rate

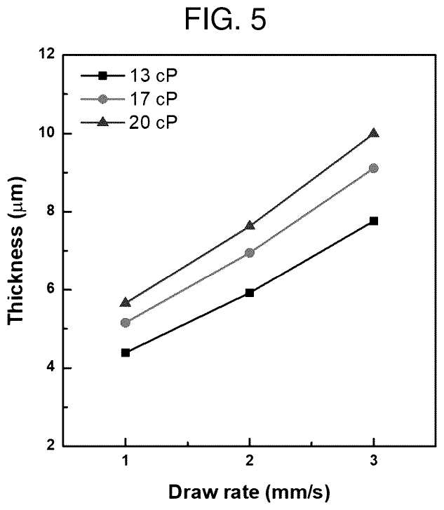

In the dip-coating process according to an exemplary embodiment of the present disclosure, the thickness of a thin film coated on a support was analyzed depending on withdrawing rate. The results are shown in FIG. 5.

FIG. 5 is a graph illustrating a change in thickness of a thin film depending on substrate withdrawing rate.

Referring to FIG. 5, it can be seen that the thickness of a thin film increases as the substrate withdrawing rate increases. It can be also seen that a thinner film is formed as the viscosity of the coating solution decreases under the condition of the same withdrawing rate, with reference to the coating solution viscosity.

A thin film having a small thickness can minimize meniscus formation caused by dip-coating. Therefore, it can be seen that as the viscosity of a coating solution decreases and as the substrate withdrawing rate decreases, a thin film having a smaller thickness is formed, thereby minimizing meniscus formation.

In addition, the following Table 1 shows surface tension and thin film thickness depending on substrate withdrawing rate and coating solution viscosity.

TABLE 1

| Draw | | | | | | | | | |
|---|---|---|---|---|---|---|---|---|---|
| rate | 1 mm/s | | | 2 mm/s | | | 3 mm/s | | |
| Vis- | 13 cP | 17 cP | 20 cP | 13 cP | 17 cP | 20 cP | 13 cP | 17 cP | 20 cP |
| cosity | | | | | | | | | |
| Surface | 43.83 | 44.46 | 45.06 | 43.83 | 44.46 | 45.06 | 43.83 | 44.46 | 45.06 |
| tension | | | | | | | | | |
| (mN/m) | | | | | | | | | |
| Thick- | 4.39 | 5.15 | 5.65 | 5.92 | 6.95 | 7.63 | 7.76 | 9.11 | 9.99 |
| ness | | | | | | | | | |
| (μm) | | | | | | | | | |

Therefore, with reference to the substrate withdrawing rate as the second parameter of a dip-coating process, it can be seen from Test Example 2 that as the substrate withdrawing rate decreases and as the viscosity of a coating solution decreases, a thin film having a smaller thickness is formed, thereby forming a uniform thin film while inhibiting meniscus formation.

### Test Example 3. Analysis of Thin Film Depending on Air Spinning

In the dip-coating processes according to Examples and Comparative Examples of the present disclosure, a gas permeation test was carried out in order to analyze thin films depending on air spinning, wherein the surface and inner part of a thin film were analyzed.

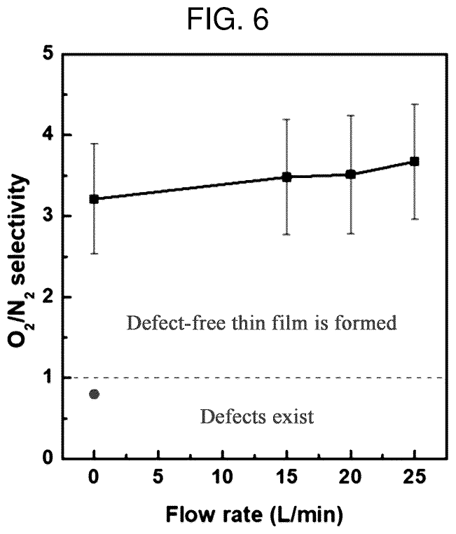

FIG. 6 is a graph illustrating oxygen/nitrogen selectivity depending on air spinning flow rate and whether air spinning is used or not. The gas permeability was determined by using CFP-1500AEL.

Referring to FIG. 6, the polymer thin film not subjected to air spinning is formed as a non-uniform thin film having defects, while the polymer thin film subjected to air spinning is formed as a defect-free dense thin film.

In addition, it can be seen from an increase in gas selectivity caused by an increase in air spinning flow rate that a defect-free dense film is formed as the flow rate increases.

Therefore, it can be seen from Test Example 3 that air spinning is carried out preferably in order to form a defect-free dense thin film, and a more uniform thin film can be formed at a higher flow rate.

### Test Example 4. Analysis of Surface Shape of Composite Membrane Formed Through Dip-Coating

In the dip-coating processes according to Examples and Comparative Examples of the present disclosure, composite membranes formed by dip-coating a porous hollow fiber membrane with 6FDA-ODA polyamic acid solution were analyzed by scanning electron microscopy (SEM) and energy dispersive X-ray spectroscopy (EDS), and their shapes were compared with one another.

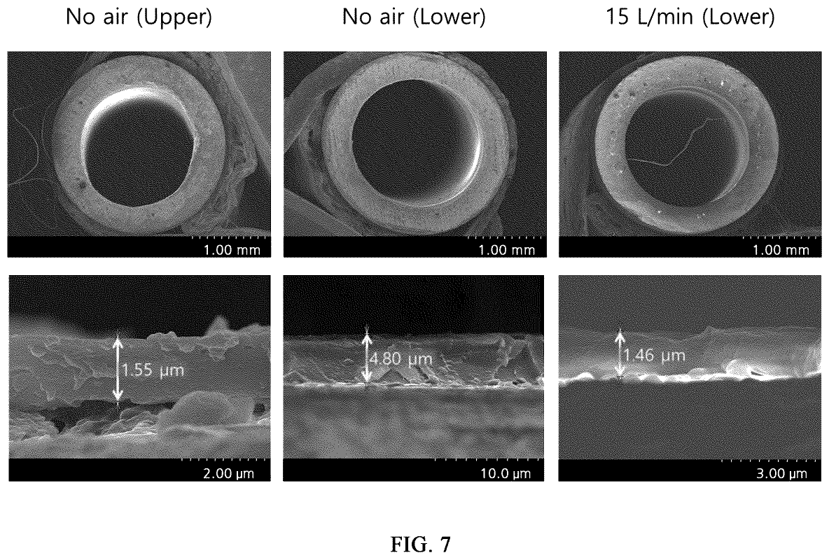

FIG. 7 is a scanning electron microscopic (SEM) image of a hollow fiber thin film composite membrane depending on whether air spinning is used or not, in a dip-coating process of a hollow fiber membrane.

Referring to FIG. 7, it can be seen that the thin film subjected to dip-coating with no air spinning is formed as a non-uniform thin film showing a difference in thickness between the upper part (thickness 1.55 μm) and the lower part (thickness 4.80 μm). On the contrary, it can be seen that the thin film subjected to dip-coating using air spinning is formed as a thin film having a uniform and constant thickness of approximately 1.46 μm as a whole.

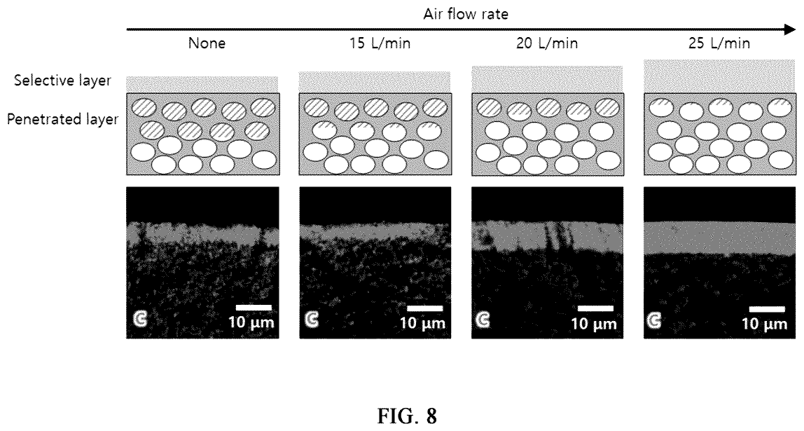

FIG. 8 is an image illustrating the cross-section of a hollow fiber thin film composite membrane depending on air spinning flow rate and whether air spinning is used or not, as analyzed by scanning electron microscopy/energy dispersive X-ray spectroscopy (SEM/EDS).

Referring to FIG. 8, it can be seen that the hollow fiber thin film composite membrane not subjected to air spinning has a non-uniformly formed coating layer and shows infiltration of the coating solution even to the inner part of hollow fibers. When air spinning is carried out at 15 L/min, a slightly more uniform coating layer is formed, but there is no significant difference. In the case of 20 L/min, it can be seen that a more uniform coating layer is formed as compared to 15 L/min.

Meanwhile, it can be seen that the hollow fiber thin film composite membrane subjected to dip-coating while carrying out air spinning at 25 L/min has a uniform coating layer formed only on the surface of the porous support.

In other words, it can be seen that the dip-coating process in which air spinning is carried out at 25 L/min shows an effect of forming a polymer thin film only on the surface to a constant thickness, which is unique to the present disclosure.

Therefore, it can be seen from Test Example 4 that the dip-coating process according to the optimum condition of the present disclosure inhibits meniscus formation and allows formation of a thin film having a uniform and constant thickness as a whole. It can be also seen that the dip-coating process in which air spinning is carried out at 25 L/min according to the optimum condition of the present disclosure shows a significantly different effect of forming a thin film on the surface with no infiltration of the coating solution to the inner part.

### Test Example 5. Analysis of Performance of Composite Membrane Depending on Air Spinning Flow Rate

In the dip-coating processes according to Examples and Comparative Examples of the present disclosure, X-ray photoelectron spectroscopy (XPS) of the hollow fiber thin film composite membrane and gas permeability/selectivity analysis were carried out depending on air spinning flow rate to perform comparative analysis of polyamic acid coating layers.

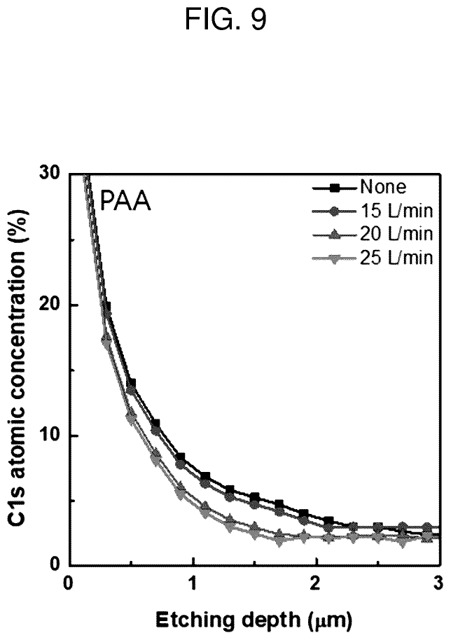

FIG. 9 is a graph illustrating a depth profile of a hollow fiber thin film composite membrane determined by XPS, depending on air spinning flow rate and whether air spinning is used or not.

Referring to FIG. 9, it can be seen that the surface is enriched with organic carbon ingredients from a high C1s atom concentration of up to about 30%, appearing in the case of the surface on which a polyamic acid (PAA) coating layer is formed. It can be also seen from a decrease in carbon ingredients caused by an increase in etching depth that the polyamic acid coating layer is mostly localized on the surface.

Particularly, it can be seen that as compared to the thin film composite membrane (None) not subjected to air spinning, a lower C1s concentration appears generally in the case of the thin film composite membranes subjected to air spinning, and a more significant effect of reducing carbon concentration is shown as the flow rate increases (25 L/min>20 L/min>15 L/min).

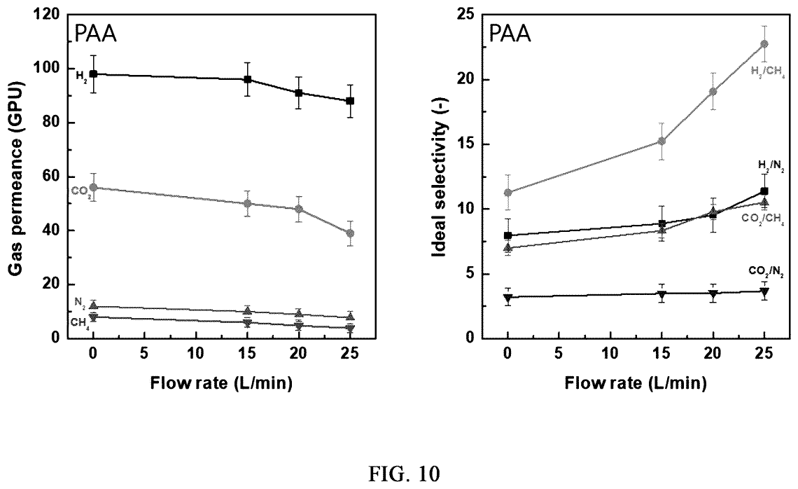

FIG. 10 is a graph illustrating gas permeability and selectivity depending on air spinning flow rate and whether air spinning is used or not.

Referring to FIG. 10, it can be seen that the permeability of each of the gases (H₂, CO₂, N₂, CH₄) gradually decreases as the air spinning flow rate increases. Particularly, it can be seen that a significant decrease in permeability appears at 25 L/min in the case of H2 and CO2, while high permeability of H2 and CO2 is maintained.

Meanwhile, with reference to the gas permeability analysis, it can be seen that separation performance of H₂/CH₄, H₂/N₂ and CO₂/CH₄ gradually increases as the air spinning flow rate increases. It can be also seen that H₂/CH₄ selectivity particularly increases by more than twice at 25 L/min.

Therefore, with reference to the air spinning flow rate as the third parameter of a dip-coating process, it can be seen from Test Example 5 that a more uniform and denser coating layer is formed as the flow rate increases, and particularly, air spinning carried out at 25 L/min can provide the most uniform thin film composite membrane having excellent separation performance as a gas separation membrane.

### Test Example 6. Analysis of Thin Film of Heat-Converted Composite Membrane

In the dip-coating processes according to Examples and Comparative Examples of the present disclosure, a gas permeation test was carried out to analyze heat-converted thin film composite membranes.

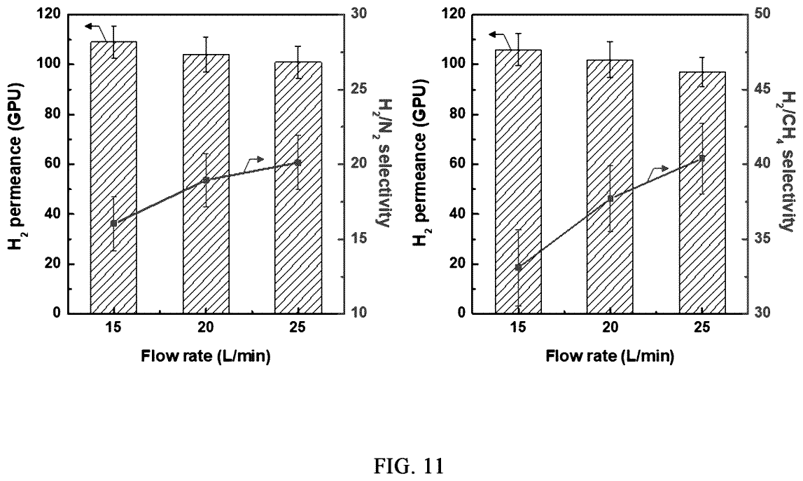

FIG. 11 is a graph illustrating gas permeability and selectivity of a heat-converted thin film composite membrane depending on air spinning flow rate and whether air spinning is used or not. The gas permeability was determined by using CFG-1500AEL.

Referring to FIG. 11, it can be seen that the polymer thin film subjected to air spinning is maintained as a defect-free dense thin film even after heat conversion.

Specifically, it can be seen from a tendency of gas permeability decreasing as the air spinning flow rate increases that a denser coating layer is formed as the flow rate increases. On the contrary, it can be seen that gas selectivity is clearly improved as the flow rate increases, wherein H₂/N₂ is increased from about 15 to 21 and H₂/CH₄ is increased from about 32 to 41.

It is thought that this results from that a dense thin film is formed, and thus a molecular sieve effect by which small molecules, H₂, can pass through the thin film but permeation of large N₂ and CH₄ is inhibited is reinforced.

Therefore, it can be seen from Test Example 6 that the polymer thin film composite membrane formed through the dip-coating process according to the present disclosure can retain a dense and uniform surface coating layer and its gas separation performance to high levels even after heat conversion.

As can be seen from the foregoing, according to the present disclosure, it is possible to form a thin film having a uniform and constant thickness by minimizing meniscus formation, which is a problem of the conventional dip-coating processes, and to form a thin film on the surface with no infiltration of a coating solution to the inner part.

In addition, it can be seen that the dip-coating process according to the present disclosure controls the three parameters (coating solution viscosity, substrate withdrawing rate, air spinning flow rate) to allow formation of uniform surface thin film coating, and thus is a process applicable to various curved materials and porous substrates and is a dip-coating process applicable to various fields requiring a thin film coating process.

What is claimed is:

1. A dip-coating apparatus comprising:
a solution tank in which a coating solution is stored;
a substrate-providing unit configured to dip a substrate in the coating solution and to withdraw the substrate out of the coating solution;
an air-discharging unit configured to supply air to the substrate at a constant flow rate when the dipped substrate is lifted up; and
a rate-controlling unit configured to control the substrate dipping rate and withdrawing rate,
wherein the substrate-providing unit comprises a tubular body configured to fix the substrate and to locate the substrate in the solution tank,
the air-discharging unit comprises a discharging tube through which air is discharged to the outside,
the discharging tube is linked with an air compressor through a tube, and
the rate-controlling unit is installed to be linked with the substrate-providing unit and is an automated device configured to insert the substrate to the solution tank at a constant rate, to allow the substrate to be dipped in the coating solution for a predetermined time and to withdraw the substrate out of the solution tank at a constant rate to be located at its original position.

2. The dip-coating apparatus according to claim 1,
wherein the substrate-providing unit dips the substrate vertically in the coating solution, and
the air-discharging unit supplies air toward the substrate as soon as the substrate is started to be lift up.

3. The dip-coating apparatus according to claim 1,
wherein the substrate-providing unit and the air-discharging unit are disposed above the solution tank, and the discharging tube of the air-discharging unit is installed downward, and thus air is supplied to the substrate while it is discharged and drop vertically.

4. The dip-coating apparatus according to claim 1,
wherein the solution tank further comprises:
a level-detecting means configured to detect the level of the coating solution; and
a level-maintaining means configured to maintain the level of the coating solution constantly.

5. The dip-coating apparatus according to claim 1,
wherein the air-discharging unit further comprises: a flow meter configured to supply air at a constant flow rate; and a feed valve.

6. The dip-coating apparatus according to claim 1,
wherein the air-discharging unit supplies air to the substrate at a constant flow rate of 1 to 25 L/min by the flow meter and feed valve.

7. The dip-coating apparatus according to claim 1,
wherein the rate-controlling unit is an automated device configured to insert the substrate to the solution tank at a rate of 0.1 to 10 mm/s, to allow the substrate to be dipped in the coating solution for 10 to 300 seconds and to withdraw the substrate out of the solution tank at the same rate to be located at its original position.

8. The dip-coating apparatus according to claim 1,
wherein the coating solution is a solution containing a polymer material and having a viscosity of 5 to 30 cP.

9. An advanced dip-coating method using the dip-coating apparatus as defined in claim 1, comprising the steps of:
(A) dipping a substrate in a coating solution for a predetermined time;
(B) withdrawing the dipped substrate out of the coating solution;
(C) supplying air to the substrate as soon as the substrate is started to be withdrawn out.

10. The advanced dip-coating method according to claim 9,
wherein the substrate is fixed at the substrate-providing unit of the dip-coating apparatus, dipped into the coating solution at a constant rate and then withdrawn out at a predetermined rate.

11. The advanced dip-coating method according to claim 9,
wherein, in step (A),
the substrate is dipped into the coating solution at a rate of 0.1 to 10 mm/s, and
the dipped substrate is retained in a dipped state for 10 to 300 seconds.

12. The advanced dip-coating method according to claim 9,
wherein, in step (B),
the substrate is withdrawn out of the coating solution at a rate of 0.1 to 10 mm/s.

13. The advanced dip-coating method according to claim 9,
wherein, in step (C),
air is supplied to the substrate from the air-discharging unit of the dip-coating apparatus at a flow rate of 1 to 25 L/min.

14. The advanced dip-coating method according to claim 9,
wherein the coating solution has a viscosity of 5 to 30 cP.

15. The advanced dip-coating method according to claim 9,
wherein the coating solution is a solution containing a polymer at 10 to 30 wt %.

16. The advanced dip-coating method according to claim 9,
wherein the polymer contained in the coating solution is at least one selected from the group consisting of polyvinyl alcohol (PVA), polyvinyl pyrrolidone (PVP), polymethyl methacrylate (PMMA), polystyrene (PS), polyimide (PI), polydimethyl siloxane (PDMS), polyvinylidene fluoride (PVDF), polyether sulfone (PES), polyetherimide (PEI), poly(3-hexylthiophene) (P3HT) and poly(3,4-ethylenedioxythiophene):polystyrene polysulfonate (PEDOT:PSS).

17. The advanced dip-coating method according to claim 9,
wherein the coating solution comprises at least one solvent selected from the group consisting of dimethylfomamide (DMF), N-methyl-2-pyrrolidoen (NMP), dimethyl sulfioxide (DMSO), dimethylacetamide (DMAc), toluene and chlorobenzene.
